(19) United States
(12) Patent Application Publication
(10) Pub. No.: US 2008/0210086 A1
(43) Pub. Date: Sep. 4, 2008

(54) Dispenser For Carburetor, Carburetor For Mocvd Using the Dispenser For Carburetor, and Carrier Gas Vaporizing Method

(76) Inventors: Masayuki Toda, Yonezawa-shi (JP); Masaki Kusuhara, Tokyo (JP)

Correspondence Address: YOUNG & THOMPSON, 209 Madison Street, Suite 500, ALEXANDRIA, VA, 22314, US

(21) Appl. No.: 10/569,137

(22) PCT Filed: Aug. 23, 2004
(86) PCT No.: PCT/JP04/12069

§ 371 Date: Apr. 14, 2006

(30) Foreign Application Priority Data
Aug. 22, 2003 (JP) 2003-298829

(51) Int. Cl. B01D 53/22; C10J 1/12

(52) U.S. Cl. 95/45; 261/78.1

(57) ABSTRACT

An object of the present invention is to provide a disperser for vaporizer capable of preventing a fluid dispersion from being crystallized when a carrier gas into which thin-film forming materials are dispersed is injected from a terminus end injection port, a vaporizer for MOCVD using the disperser for vaporizer, and a carrier gas vaporizing method. A plurality of thin-film forming materials are dispersed into a carrier gas introduced into a gas passage by a dispersion section located in a midway portion of a gas passage 35 into which the carrier gas is introduced. An air flow substantially along the injection direction of carrier gas into which the plurality of thin-film forming materials injected from an terminus end injection port 35b are dispersed is injected from an air flow injection port 38 formed near the terminus end injection port 35b located in the downstream end portion of the gas passage 35.

### TECHNICAL FIELD

The present invention relates to a disperser for a vaporizer for vaporizing a plurality of source solutions etc. using a carrier gas, a vaporizer for MOCVD using this disperser for vaporizer, and a carrier gas vaporizing method.

### BACKGROUND ART

Patent Document 1: Unexamined Japanese Patent Publication No. 2000-216150

In recent years, in the field of electronic device, as the circuit density increases, smaller size and higher performance of electronic device have further been demanded. For example, like SRAM (Static Random Access read write Memory) in which storage operation of information is performed by a combination of transistors, EEPROM (Electrically Erasable and Programmable Read Only Memory), or DRAM (Dynamic Random Access Memory) in which storage operation of information is performed by a combination of transistors and capacitors, not only the fulfillment of function of electronic device achieved simply by a circuit configuration only but also the fulfillment of function of device achieved by utilizing the characteristics of the material itself such as a functional thin film has become advantageous.

Therefore, a dielectric material used for an electronic part is desired to be made a thin film. One method for making such a material a thin film is the CVD process.

This CVD process has features of a film forming rate higher than that of the PVD process, sol-gel process, and other film forming methods, easy manufacture of multilayer thin film, and the like. Also, the MOCVD process is a CVD process in which a compound containing an organic substance is used as a raw material for forming a thin film, and has advantages of high safety, no mixture of halide in a film, and the like.

The material used for the MOCVD process is generally solid powder or liquid. In this process, the material is put in a vessel, and is generally heated at a reduced pressure and vaporized in a vaporizer, and thereafter is sent into a thin-film forming apparatus by a carrier gas.

FIG. 4 is a system block diagram of a vaporization system for the MOCVD process (refer to Patent Document 1).

In FIG. 4, reference numeral 10 denotes a supply section for supplying a plurality of source solutions etc. to a vaporizer 1.

The supply section 10 includes a gas cylinder 11 filled with a carrier gas (for example, N2 or Ar), an oxygen cylinder 12 filled with oxygen, a water storage tank 13 in which cooling water is stored, a plurality of reservoirs 14 to 17 in which raw materials for ferroelectric thin film (for example, Sr(DPM)2, Bi(C6H5)3, Ta(OC2H5)5 as three kinds of organometallic complexes) and THF (tetrahydrofuran) as a solvent are stored, a gas feed pipe 18 connected to the gas cylinder 11 and the vaporizer 1, an oxygen feed pipe 19 connected to the oxygen cylinder 12 and the vaporizer 1, a water feed pipe 20 and a water distribution pipe 21, which are connected to the water storage tank 13 and the vaporizer 1, liquid feed pipes 22 to 25 which are connected to the reservoirs 14 to 17 and the vaporizer 1, and a manifold 26 connected to the reservoirs 14 to 17 and the gas cylinder 11.

In the path of the gas feed pipe 18 are provided a valve 18a and a mass flow controller 18b, in the path of the oxygen feed pipe 19 are provided a valve 19a, a mass flow controller 19b, and a valve 19c, in the path of the water feed pipe 20 is provided a valve 20a, in the path of the liquid feed pipe 22 for solvent are provided a valve 22a and a mass flow controller 22b, in the paths of the liquid feed pipes 23 to 25 for complex are provided valves 23a to 25a and mass flow controllers 23a to 25b, respectively, and in the path of the manifold 26 are provided valves 26a to 26d, an air purge 26e, and a valve 26f. The liquid feed pipes 23 to 25 are branched so as to be connected to the liquid feed pipe 22, and are provided with valves 23c to 25c, respectively.

The carrier gas filled in the gas cylinder 11 is supplied to the vaporizer 1 while the flow rate thereof is controlled by the mass flow controller 18b by opening the valve 18a of the gas feed pipe 18. Also, the carrier gas filled in the gas cylinder 11 is set into the reservoirs 14 to 17 by opening the valve 26f and the valves 26a to 26d of the manifold 26 and by closing the release state of the air purge valve 26e. Thereby, the interiors of the reservoirs 14 to 17 are pressurized by the carrier gas, and the stored source solutions are pushed into the liquid feed pipes 22 to 25 the tip end of which are put in the solutions, and are transported into connection pipes 2 to 5 of the vaporizer 1 after the flow rates thereof have been controlled by the mass flow controllers 22b to 25b.

Also, at the same time, the oxygen (oxidizing agent), the flow rate of which is controlled to a fixed value by the mass flow controller 19b, is transported from the oxygen cylinder 12 to the vaporizer 1.

Further, by opening the valve 20a of the water feed pipe 20, the cooling water in the water storage tank 13 circulates in the vaporizer 1 to cool the vaporizer 1.

In the illustrated example, connection pipes 27 to 30 are provided side by side along the axis line direction of the vaporizer 1. Actually, however, the connection pipes 27 to 30 are provided radially and alternately by connection pipes 31 and 32 connected to the water feed pipe 20 or the water distribution pipe 21 leading to the water storage tank 13.

The source solution stored in the reservoirs 15 to 17 is a solution in which a liquid or solid organometallic complex (Sr(DPM)2, Bi(C6H5)3, Ta(OC2H5)5) is dissolved in THF, which is a solvent, at ordinary temperature. Therefore, if the source solution is allowed to stand as it is, the organometallic complex is deposited by the evaporation of THF solvent, and finally becomes in a solid state. For this reason, in order to prevent the interiors of the liquid feed pipes 23 to 25 that come into contact with the source solution from being clogged by the solid-state organometallic complex, the interiors of the liquid feed pipes 23 to 25 and the interior of the vaporizer 1 should be cleaned by THF in the reservoir 14 after the film forming work has been finished. At this time, the cleaning operation is performed in a section from the outlet side of the mass flow controller 13b to 25b to the vaporizer 1, and the THF stored in the reservoir 14 is washed away after the work has been finished.

FIG. 3 is a sectional view showing a construction of an essential portion of the vaporizer 1. In FIG. 3, the vaporizer 1 includes a disperser 2 to which the gas feed pipe 18 is connected, a reaction tube 3 connected continuously to the downstream side of the disperser 2, and a heater 4 covering the periphery of the reaction tube 3.

The disperser 2 has a gas passage 5 located coaxially with the gas feed pipe 18. Between a start end upstream port 5a and a terminus end injection port 5b of the gas passage 5, the tip ends of the connection pipes 27 to 30 are located (in FIG. 3, only the opposedly arranged connection pipes 28 and 29 are shown). Thereby, the source solutions stored in the reservoirs 15 to 17 can be supplied into the gas passage 5. Also, the disperser 2 is formed with a cooling path 6 which communicates with the connection pipes 31 and 32 and in which the cooling water in the water storage tank 13 circulates. Further, the disperser 2 includes a rod 7 one end of which is located on the upstream side of the start end upstream port 5a of the gas feed pipe 18 and the other end of which is located at the position of the terminus end injection port 5b, and pins 8 for supporting the other end of the rod 7. One end of the rod 7 is held by pins 9 provided near the end portion of the gas feed pipe 18.

In the above-described configuration, a hole is penetratingly provided in the disperser 2, and the rod 7 having an outside diameter (4.48 mm) smaller than the inside diameter (4.50 mm) of the hole is embedded so as to be located coaxially with the axis line of the hole. The gas passage 5 is formed in a space formed between the disperser 2 and the rod 7. The rod 7 is held in a positioned state by the machine screws 9.

The cross section width of the gas passage 5 is 0.02 mm. At this time, the cross section width of the gas passage 5 is preferably 0.005 to 0.10 mm. If the cross section width is narrower than 0.005 mm, fabrication is difficult to do, and if it exceeds 0.10 mm, a high-pressure carrier gas must be used to increase the velocity of carrier gas.

From the upstream side of the gas passage 5, the carrier gas is introduced through the gas feed pipe 18. Since the source solution is dripped in this carrier gas from the tip ends of the connection pipes 27 to 30 located in midway portions of the gas passage 5, the source solution is dispersed into the carrier gas passing through the gas passage 5.

Thereby, the carrier gas into which the source solutions are dispersed is injected from the terminus end injection port 5b on the downstream side of the gas passage into the reaction tube 3. The carrier gas, into which the source solutions are dispersed and which flows in the reaction tube 3, is heated and vaporized by the heater 4, and thereafter is sent to a thin-film forming apparatus, not shown.

### DISCLOSURE OF THE INVENTION

### Problems to be Solved by the Invention

In the vaporizer for MOCVD configured as described above, there arises a problem in that when the carrier gas into which the source solutions are dispersed is injected from the terminus end injection port 5b, a fluid dispersion is crystallized and remains at the opening end of the terminus end injection port 5b, so that if the crystallized fluid dispersion is allowed to stand as it is, the terminus end injection port 5b is clogged.

The present invention has been made to solve the above problem, and accordingly an object thereof is to provide a disperser for vaporizer capable of preventing a fluid dispersion from being crystallized when a carrier gas into which thin-film forming materials are dispersed is injected from a terminus end injection port, a vaporizer for MOCVD using this disperser for vaporizer, and a carrier gas vaporizing method.

### Means for Solving the Problems

To achieve the above object, a disperser for vaporizer described in claim 1 is characterized by including a gas passage into which a carrier gas is introduced; a dispersion section located in a midway portion of the gas passage to disperse a plurality of thin-film forming materials into the carrier gas introduced into the gas passage; and an air flow injection port which is formed near a terminus end injection port located in the downstream end portion of the gas passage to prevent crystal deposits from adhering to the terminus end injection port by means of the injection of an air flow substantially along the injection direction of carrier gas into which the plurality of thin-film forming materials injected from the terminus end injection port are dispersed.

A disperser for vaporizer described in claim 2 is characterized by including a gas passage into which a carrier gas is introduced; a dispersion section located in a midway portion of the gas passage to disperse a plurality of thin-film forming materials into the carrier gas introduced into the gas passage; and an air flow injection opening which is formed along a wall surface near a terminus end injection port located in the downstream end portion of the gas passage to prevent a crystal film from adhering to the terminus end injection port by means of the wide-range injection of an air flow substantially along the injection direction of carrier gas into which the plurality of thin-film forming materials injected from the terminus end injection port are dispersed.

A disperser for vaporizer described in claim 3 is characterized in that the opening end of the air flow injection opening is covered with a porous filter.

A disperser for vaporizer described in claim 4 is characterized in that the air flow is some of carrier gas.

A vaporizer for MOCVD described in claim 5 is characterized in that a vaporization section for vaporizing the carrier gas into which the plurality of thin-film forming materials are dispersed in the dispersion section is provided adjacently to the disperser for vaporizer described in any one of claims 1 to 4.

A carrier gas vaporizing method described in claim 6 is characterized in that after thin-film forming materials have been introduced from a plurality of locations in a midway portion of a gas passage and dispersed into a carrier gas, the carrier gas into which the thin-film forming materials are dispersed is injected from a terminus end injection port located in the downstream end portion of the gas passage, and also an air flow substantially along the injection direction of carrier gas is injected from near the terminus end injection port, by which a crystal film is prevented from adhering to the terminus end injection port.

### ADVANTAGES OF THE INVENTION

According to the disperser for vaporizer described in claim 1, the plurality of thin-film forming materials are dispersed into the carrier gas introduced into the gas passage by the dispersion section located in a midway portion of the gas passage into which the carrier gas is introduced, and an air flow substantially along the injection direction of carrier gas into which the thin-film forming materials injected from the terminus end injection port are dispersed is injected by the air flow injection port formed near the terminus end injection port located in the downstream end portion of the gas passage, by which a crystal film is prevented from adhering to the terminus end injection port.

### BRIEF DESCRIPTION OF THE DRAWINGS

FIG. 1 is a sectional view of an essential portion showing example 1 of a vaporizer for MOCVD in accordance with the present invention;

FIG. 2 is a sectional view of an essential portion showing example 2 of a vaporizer for MOCVD in accordance with the present invention;

FIG. 3 is a sectional view of an essential portion showing a conventional vaporizer for MOCVD; and

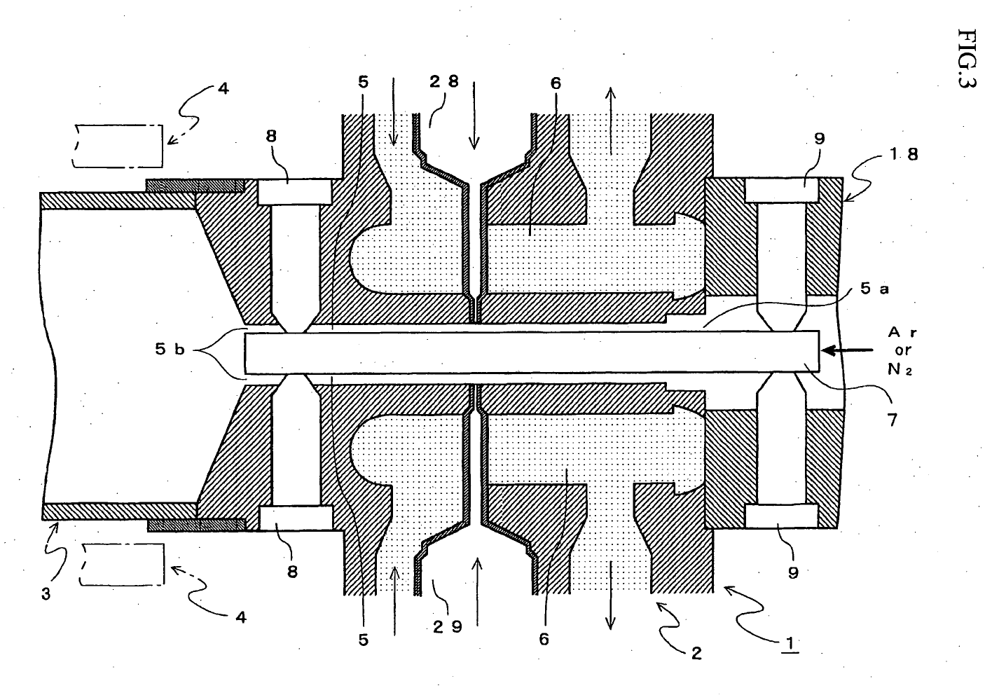

FIG. 4 is a system block diagram of a vaporization system for the MOCVD process.

### EXPLANATION OF SYMBOLS

1 . . . vaporizer
2 . . . disperser
3 . . . reaction tube
4 . . . heater
35 . . . gas passage
35a . . . start end upstream port
35b . . . terminus end injection port (junction portion)
38 . . . air flow injection port
48 . . . air flow injection opening
49 . . . porous filter

### BEST MODE FOR CARRYING OUT THE INVENTION

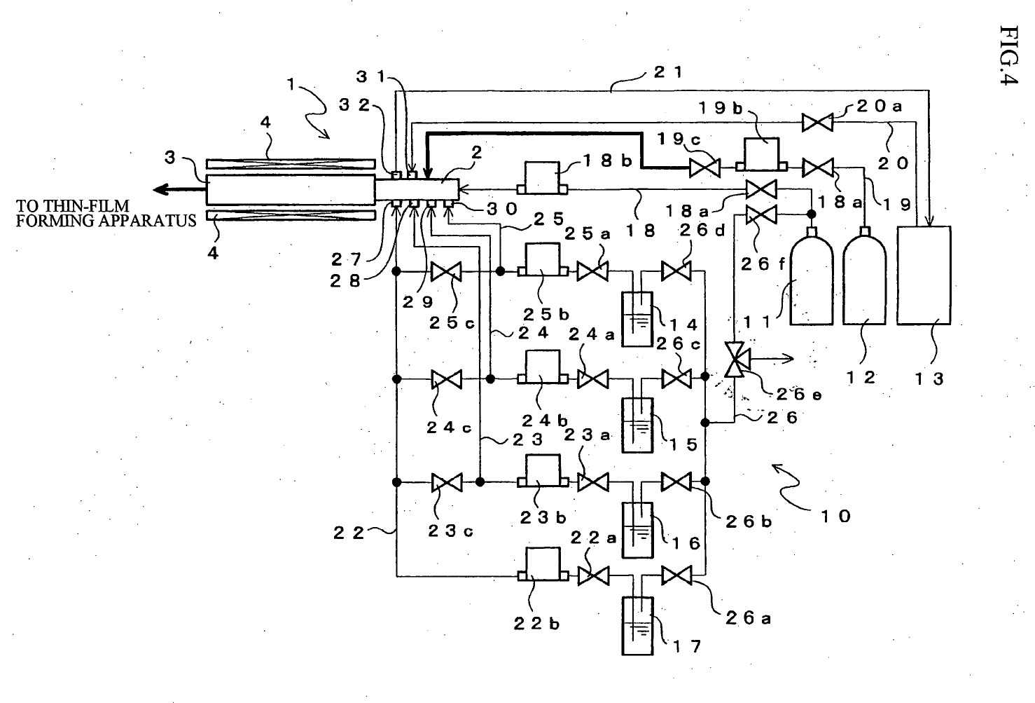

A vaporizer for MOCVD in accordance with the present invention will now be described with reference to the accompanying drawings. In the examples described below, an apparent system configuration of a raw material supply system etc. is the same as that shown in FIG. 4, and therefore the detailed explanation of the whole of the system is omitted.

### Example 1

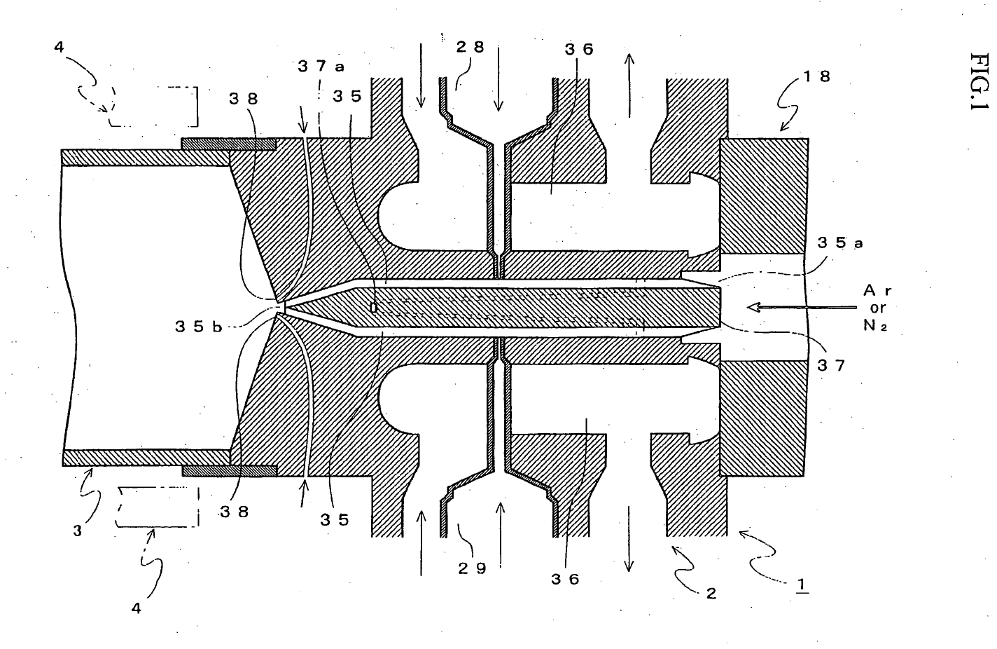

FIG. 1 shows example 1 of a vaporizer for MOCVD in accordance with the present invention.

In FIG. 1, a vaporizer 1 includes a disperser 2 to which a gas feed pipe 18 is connected, a reaction tube 3 connected continuously to the downstream side of the disperser 2, and a heater 4 covering the periphery of the reaction tube 3. The reaction tube 3 and the heater 4 constitute a vaporization section.

The disperser 2 has a gas passage 35 located coaxially with the gas feed pipe 18. Between a start end upstream port 35a and a terminus end injection port 35b of the gas passage 35, the tip ends (dispersion section) of connection pipes 27 to 30 are located (in FIG. 1, only the opposedly arranged connection pipes 28 and 29 are shown). Thereby, the source solutions stored in reservoirs 15 to 17 can be supplied into the gas passage 35. Also, the disperser 2 is formed with a cooling path 36 which communicates with connection pipes 31 and 32 and in which the cooling water in a water storage tank 13 circulates. Further, the disperser 2 includes a rod 37 one end of which is located at the start end upstream port 35a and the other end of which is located at the terminus end injection port 5b. Also, the disperser 2 has an air flow injection port 38 that is open near the terminus end injection port 35b so that some of carrier gas (or oxygen) is introduced into the air flow injection port 38.

The tip end portion of the rod 37 is tapered in the axial direction from a midway portion toward the terminus end injection port 35b, and the rod 37 forms the gas passage 35 in cooperation with the hole inner wall of the disperser 2. Also, the rod 37 is formed with a cooling path 37a for circulating the cooling water in the water storage tank 13 (or a liquid or a gas from a separate tank). The tip end portion of the rod 37 is formed into a conical (or truncated conical) shape. By forming the hole inner wall of the disperser 2 so as to follow the tip end shape, the gas passages 35 join at the terminus end injection port 35b. This tip end portion may have a pyramid (or truncated pyramid) shape. Also, the junction portion of the terminus end injection port 35b may be located on the upstream side of the terminus end injection port 35b in the carrier gas conveyance direction.

In the above-described configuration, when the carrier gas into which a plurality of thin-film forming materials are dispersed is injected from the terminus end injection port 35b, an air flow (some of carrier gas or oxygen) substantially along the injection direction of the carrier gas into which the thin-film forming materials are dispersed is injected from the air flow injection port 38, by which a crystal film is prevented from adhering to the terminus end injection port 35b.

### Example 2

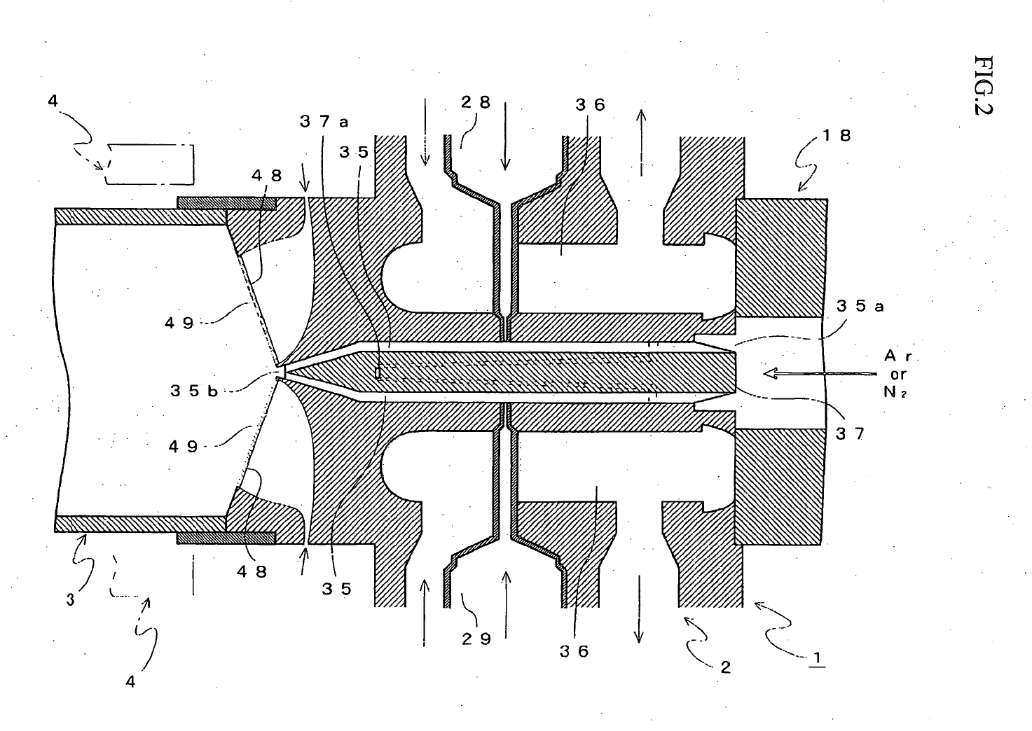

FIG. 2 shows example 2 of a vaporizer for MOCVD in accordance with the present invention.

In FIG. 2, the vaporizer 1 includes the disperser 2 to which the gas feed pipe 18 is connected, the reaction tube 3 connected continuously to the downstream side of the disperser 2, and the heater 4 covering the periphery of the reaction tube 3. The reaction tube 3 and the heater 4 constitute the vaporization section.

The disperser 2 has the gas passage 35 located coaxially with the gas feed pipe 18. Between the start end upstream port 35a and the terminus end injection port 35b of the gas passage 35, the tip ends (dispersion section) of the connection pipes 27 to 30 are located (in FIG. 2, only the opposedly arranged connection pipes 28 and 29 are shown). Thereby, the source solutions stored in the reservoirs 15 to 17 can be supplied into the gas passage 35. Also, the disperser 2 is formed with the cooling path 36 which communicates with the connection pipes 31 and 32 and in which the cooling water in the water storage tank 13 circulates. Further, the disperser 2 includes a rod 37 one end of which is located at the start end upstream port 35a and the other end of which is located at the terminus end injection port 35b. Also, the disperser 2 has an air flow injection opening 48 that is open in a wall surface forming the terminus end injection port 35b so that some of carrier gas (or oxygen) is introduced into the air flow injection opening 48. The opening end of the air flow injection opening 48 is covered with a porous filter 49.

The tip end portion of the rod 37 is tapered in the axial direction from a midway portion toward the terminus end injection port 35b, and the rod 37 forms the gas passage 35 in cooperation with the hole inner wall of the disperser 2. Also, the rod 37 is formed with the cooling path 37a for circulating the cooling water in the water storage tank 13 (or a liquid or a gas from a separate tank). The tip end portion of the rod 37 is formed into a conical (or truncated conical) shape. By forming the hole inner wall of the disperser 2 so as to follow the tip end shape, the gas passages 35 join at the terminus end injection port 35b. This tip end portion may have a pyramid (or truncated pyramid) shape. Also, the junction portion of the terminus end injection port 35b may be located on the upstream side of the terminus end injection port 35b in the carrier gas conveyance direction.

In the above-described configuration, when the carrier gas into which the plurality of thin-film forming materials are dispersed is injected from the terminus end injection port 35b, an air flow (some of carrier gas or oxygen) substantially along the injection direction of the carrier gas into which the thin-film forming materials are dispersed is injected from the air flow injection opening 48, by which a crystal film is prevented from adhering to the terminus end injection port 35b.

### INDUSTRIAL APPLICABILITY

According to the disperser for vaporizer described in claim 1, a plurality of thin-film forming materials are dispersed into a carrier gas introduced into the gas passage by the dispersion section located in a midway portion of the gas passage into which the carrier gas is introduced, and an air flow substantially along the injection direction of carrier gas into which the thin-film forming materials injected from the terminus end injection port are dispersed is injected by the air flow injection port formed near the terminus end injection port located in the downstream end portion of the gas passage, by which a crystal film is prevented from adhering to the terminus end injection port.

1. A disperser for vaporizer characterized by comprising a gas passage into which a carrier gas is introduced; a dispersion section located in a midway portion of the gas passage to disperse a plurality of thin-film forming materials into the carrier gas introduced into the gas passage; and an air flow injection port which is formed near a terminus end injection port located in the downstream end portion of the gas passage to prevent crystal deposits from adhering to the terminus end injection port by means of the injection of an air flow substantially along the injection direction of carrier gas into which the plurality of thin-film forming materials injected from the terminus end injection port are dispersed.

2. A disperser for vaporizer characterized by comprising a gas passage into which a carrier gas is introduced; a dispersion section located in a midway portion of the gas passage to disperse a plurality of thin-film forming materials into the carrier gas introduced into the gas passage; and an air flow injection opening which is formed along a wall surface near a terminus end injection port located in the downstream end portion of the gas passage to prevent a crystal film from adhering to the terminus end injection port by means of the wide-range injection of an air flow substantially along the injection direction of carrier gas into which the plurality of thin-film forming materials injected from the terminus end injection port are dispersed.

3. The disperser for vaporizer according to claim 2, characterized in that the opening end of the air flow injection opening is covered with a porous filter.

4. The disperser for vaporizer according to claim 1, characterized in that the air flow is some of carrier gas.

5. A vaporizer for MOCVD characterized in that a vaporization section for vaporizing the carrier gas into which the plurality of thin-film forming materials are dispersed in the dispersion section is provided adjacently to the disperser for vaporizer described in claim 1.

6. A carrier gas vaporizing method characterized in that after thin-film forming materials have been introduced from a plurality of locations in a midway portion of a gas passage and dispersed into a carrier gas, the carrier gas into which the thin-film forming materials are dispersed is injected from a terminus end injection port located in the downstream end portion of the gas passage, and also an air flow substantially along the injection direction of carrier gas is injected from near the terminus end injection port, by which a crystal film is prevented from adhering to the terminus end injection port.

7. The disperser for vaporizer according to claim 2, characterized in that the air flow is some of carrier gas.

8. The disperser for vaporizer according to claim 3, characterized in that the air flow is some of carrier gas.

9. A vaporizer for MOCVD characterized in that a vaporization section for vaporizing the carrier gas into which the plurality of thin-film forming materials are dispersed in the dispersion section is provided adjacently to the disperser for vaporizer described in claim 2.

10. A vaporizer for MOCVD characterized in that a vaporization section for vaporizing the carrier gas into which the plurality of thin-film forming materials are dispersed in the dispersion section is provided adjacently to the disperser for vaporizer described in claim 3.

11. A vaporizer for MOCVD characterized in that a vaporization section for vaporizing the carrier gas into which the plurality of thin-film forming materials are dispersed in the dispersion section is provided adjacently to the disperser for vaporizer described in claim 4.
